(19) United States
(12) Patent Application Publication
(10) Pub. No.: US 2009/0207590 A1
(43) Pub. Date: Aug. 20, 2009

(54) Solar illuminated knob device

(76) Inventor: Kao-Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/071,074

(22) Filed: Feb. 15, 2008

(51) Int. Cl. E05B 17/00; F21L 4/00

(52) U.S. Cl. 362/100; 362/194

(57) ABSTRACT

A solar illuminated knob device comprises a lighting component disposed within a knob. The lighting component includes an indicating lamp, a solar panel, a storage battery, a switch and a circuit board. The solar panel is fixed to the outer surface of the knob. The indicating lamp and the switch are also installed on the knob, and the storage battery and the circuit board are disposed in the accommodating space inside the knob. The illuminated knob has the advantages of protecting the environment and saving energy since the solar panel is used as a power source for the lighting component, thereby avoiding the line arrangement required by AC or DC illumination.

### BACKGROUND OF THE INVENTION

(a) Field of the Invention

The creation relates to an illumination device for a knob, and, more particularly, to an illumination mechanism for a knob without the need of an external power source and utilizing solar energy as electric power.

(b) Description of the Prior Art

The adjustment of devices or machinery equipment used outdoors often needs to be conducted in the environment of poor visibility, for example, at night. In order to obtain more exact adjustment results, additional illumination manners, such as peripheral light illumination, flash light illumination, and the like are usually employed to assist the adjustment of a knob. Moreover, there is a means of directly installing indicating lamps on a knob.

For example, in consideration of that barbecues usually take place outdoors at nightfall and the environmental visibility is relatively poor, some oven manufacturers often install indicating lamps on the knob of the oven or the control panel thereof.

However, the control panel of the oven is next to the heat generation source and its environmental temperature is relatively high, so that the aging of the wire insulating layer would be accelerated thereby reducing the service life. Furthermore, the gas pipe and the ignition pipe have occupied a lot of space so that the indicating lamp wiring would become more difficult. If carelessness during assembling or wire breakage, even the damage of the wire insulating layer due to the high temperature occurs, all of them may result in the hazard of electrical leakage or electric shock, even hurt the users when serious.

Therefore, there is an urgent demand for an illuminated knob device, which is safe in use, with regard to the knobs required for adjustment outdoors.

### SUMMARY OF THE INVENTION

The creation that has been made to solve the technical problems in view of the present technical situation is to provide a solar illumination mechanism for a knob, which is simply structured, energy-saving, environment-protecting, safe in use and without the need of an additional line arrangement.

In order to solve the above technical problems, the creation provides a lighting component which is disposed within a knob, the lighting component including an indicating lamp, a solar panel, a storage battery, a switch and a circuit board; wherein said solar panel is fixed to the outer surface of the knob, and said indicating lamp and said switch are installed on the knob, and the storage battery and the circuit board are disposed in the accommodating space inside the knob.

According to the creation, since all of the lighting components are disposed at the knob, the high temperature aging can be prevented when the knob is mounted on high heat generating equipment, thereby increasing the service life and enhancing the safety in use. Furthermore, the solar panel is utilized in the lighting components so that the creation has the advantages of protecting environment and saving energy, thereby avoiding the problems of the line arrangement required by AC or DC illumination.

In the implementation of the creation, said indicating lamp can be installed on the outer surface of the knob for the convenience of the indicating lamp illuminating the entire knob.

Said solar illumination mechanism for a knob further comprises a knob base, wherein the knob is disposed on the middle portion of the knob base, and said knob base is a hollow ring with a “U” shaped or a triangular longitudinal section, a collecting comb, which is provided thereon with positive and negative combs and is disposed within the ring groove around the periphery of the knob base, and a brush plate, which matches the collecting comb, wherein the brush plate is fixed to the bottom surface of the knob and can rotate synchronously with the knob, and positive and negative brushes are fixed to said brush plate corresponding to the positive and negative combs; a number of indicating lamps are fixed to said collecting comb.

The design of the above collecting comb and brush plate can utilize the working principle of the comb and the brush. Indicating lamps are arranged on the collecting comb in accordance with the graduations corresponding to the turn of the knob. The different indicating lamp can be actuated to emit light through the line connection between the different conductors on the comb and the brush, thereby exactly indicating the working state of the knob.

The number of said indicating lamps arranged can depend on the requirements of the graduations of the knob. There are generally 6 indicating lamps arranged uniformly around the periphery of the collecting comb.

In the implementation of the creation, a light emitting diode is suitably used as the indicating lamp in order to have the advantages of low power consumption, saving energy and long service life.

Additionally, said knob can be designed to be cylindrical, and the solar panel is installed on the circular front face of the knob.

Furthermore, and a photoswitch can be utilized as said switch which is installed on the outer surface of the knob. The photoswitch can automatically turn off or on the illumination circuit in accordance with the light intensity for the convenience of use.

It is definite that the above photoswitch can be further series connected with a manual switch such that the circuit would be shut down when it is unemployed for a long time to prevent the loss of parts.

Compared with the prior art, the creation has the following advantages:

1. According to the creation, all of the lighting components are disposed at the knob, so that, when in use, the problems of the line arrangement required by AC or DC illumination, even the high temperature aging due to the circuit arrangement with the other high temperature generating components can be avoided, thereby to achieve the effect of increasing the service life and enhancing the safety in use. Furthermore,

2. The solar panel is utilized in the lighting components of the creation as a power source so that the creation has the advantages of protecting environment and saving energy.

3. The collecting comb and the brush plate can exactly indicate the working state of the knob in coordination with the use of the indicating lamps so that the creation offers the convenience of use.

4. The photoswitch is designed such that the indicating lamps can be automatically turned off or on in accordance with the peripheral visibility. Also, the series connection with a manual switch can prevent the loss of parts in the case where the product is transported and it is unemployed for a long time.

### BRIEF DESCRIPTION OF THE DRAWINGS

The creation will become apparent from the following detailed description of the preferred embodiment taken in conjunction with the accompanying drawings.

FIG. 1 is a three dimensional view showing an appearance of a first embodiment according to the creation.

FIG. 2 is an exploded view of a first embodiment according to the creation.

FIG. 3 is a side sectional view of a first embodiment according to the creation.

FIG. 4 is a schematic view showing an arrangement inside a knob of a first embodiment according to the creation.

FIG. 5 is a schematic view showing a circuit arrangement of a first embodiment according to the creation.

FIG. 6 is an exploded view of a second embodiment according to the creation.

FIG. 7 is a schematic view showing the working principle of a collecting comb and a brush plate of a second embodiment according to the creation.

FIG. 8 is a side view showing a collecting comb of a second embodiment according to the creation.

FIG. 9 is a side view showing a brush plate of a second embodiment according to the creation.

FIG. 10 is a three dimensional schematic view showing the creation applied to an oven.

### DETAILED DESCRIPTION OF THE PREFERRED EMBODIMENTS

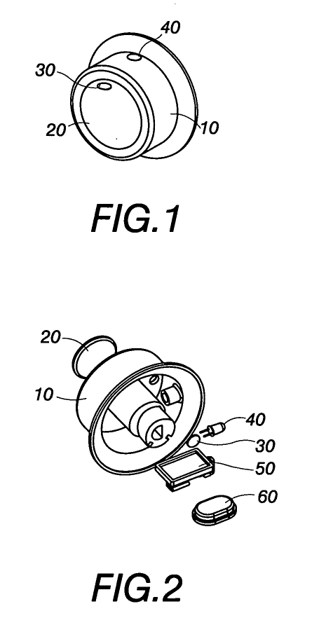

As illustrated in FIGS. 1 to 4, there is a first embodiment of the creation. The illuminated knob device according to the creation disclosed in the drawings comprises at least one knob 10, a solar panel 20, a photoswitch 30, an indicating lamp 40, a circuit board 50 and a storage battery 60.

As illustrated in FIGS. 1 and 2, said knob 10 is cylindrical and the solar panel 20 is installed on the outer surface of the knob 10. Said solar panel 20 can function as a part of casing of the knob 10, thus capable of saving the material of the knob 10 as well as absorbing and transforming the solar energy. Said photoswitch 30 is a photosensor, which is installed on the outer surface of the knob 10 in favor of detecting the peripheral visibility. Said indicating lamp 40 can be a LED and installed on the cylindrical surface of the knob 10.

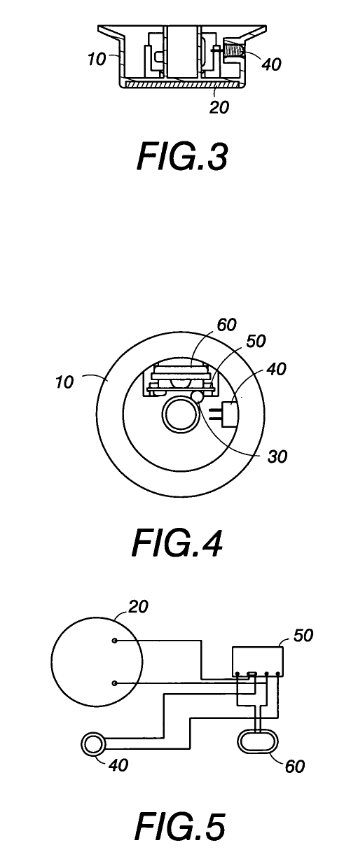

As illustrated in FIGS. 3 and 4, said storage battery 60 and said circuit board 50 are disposed in the accommodating space inside the knob 10, wherein a micro storage battery or a button type storage battery is adopted as the storage battery 60, and the size of the storage battery 60 can be designed according to the size of the accommodating space inside the knob. Due to the very low power consumption of the indicating lamp 40, the storage capacity of the storage battery 60 can provide illumination for 4 to 5 hours even in a cloudy weather.

The working principle of the solar panel 20, the photoswitch 30, the indicating lamp 40, the circuit board 50 and the storage battery 60 is as shown in FIG. 5. The solar energy absorbed by the solar panel 20 is transformed via the relative circuit of the circuit board 50 and stored into the storage battery 60. The photoswitch 30 selectively turns on or off in accordance with the detected visibility data, and the circuit board 50 delivers the electric energy stored in the storage battery 60 to the indicating lamp 40 for illumination in accordance with the instruction from the photoswitch 30.

Therefore, when the visibility and the illuminance are sufficient in the daytime, the solar energy absorbed by the solar panel 20 is transformed via the relative circuit of the circuit board 50 and stored into the storage battery 60; when the visibility is poor at night, the circuit board 50 delivers the electric energy stored in the storage battery 60 to the indicating lamp 40 for illumination in accordance with the enabling signal from the photoswitch 30, thereby to achieve the purpose of automatically illuminating and indicating as described above.

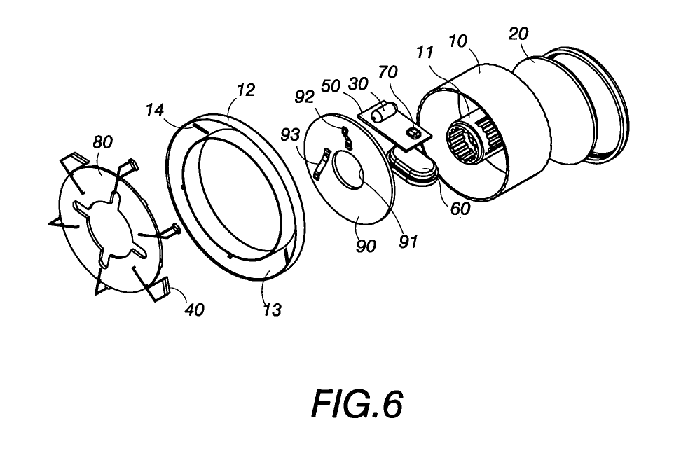

As illustrated in FIG. 6, there is a second embodiment of the creation. The knob device according to the creation disclosed in the drawings further comprises a manual switch 70, a collecting comb 80 and a brush plate 90 in addition to the knob 10, the solar panel 20, the photoswitch 30, the indicating lamp 40, the circuit board 50 and the storage battery 60.

Wherein said knob 10 is cylindrical, same as the foregoing embodiment, and the solar panel 20 is fixed to the circular outer face thereof. A ring-shaped securing post 11 is fixed to the circular inner face of the knob 10. The circuit board 50 and the storage battery 60 are disposed in the accommodating space inside the knob 10. Said knob 10 is disposed on a knob base 12.

Said knob base 12 is a hollow cylindrical ring with a “U” shaped groove 13, and there are a plurality of graduation holes 14 on the outer surface of the knob base 12. The collecting comb 80 is mounted in the “U” shaped groove 13 of the knob base 12.

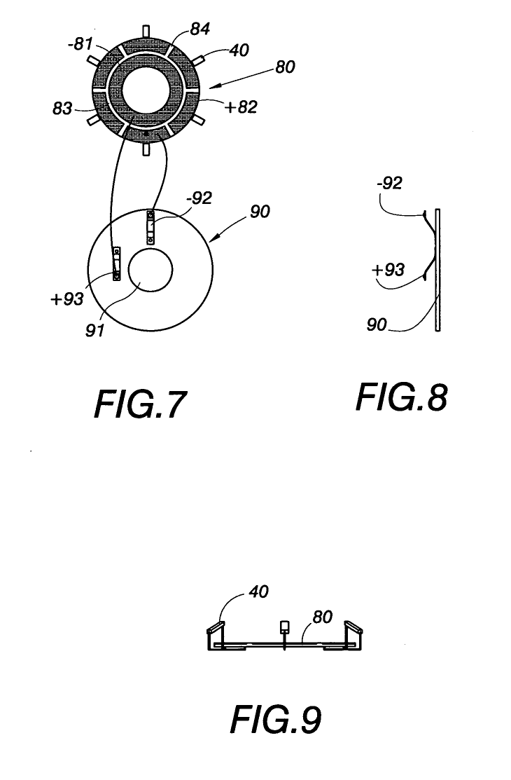

As illustrated in FIGS. 6, 7 and 9, said collecting comb 80 is ring-shaped, around the periphery of which light emitting diode indicating lamps 40 are uniformly fixed corresponding to the graduation holes 14 on the knob base 12, the inner ring on the inner surface of which is provided with a negative comb 81 and the outer ring on the inner surface of which is provided with positive combs 82 and there is an insulating ring 83 between the positive combs 82 and the negative comb 81. Said positive combs 82 are uniformly spaced by insulating strips 84 into a plurality of pieces corresponding to the indicating lamps 40. In the drawings, there are six positive combs 82 and indicating lamps 40 respectively.

As illustrated in FIGS. 6, 7 and 8, said brush plate 90 is ring-shaped, the size of the central circular aperture 91 of which matches that of the securing post 11 inside the knob 10; the securing post 11 penetrates through the circular aperture 91 and is fixed to the bottom of the knob 10. A negative brush 92 and a positive brush 93 are respectively fixed to the inner side face of the brush plate 90 corresponding to the positive combs 82 and the negative comb 81 on the collecting comb 80.

All of the above-mentioned solar panel 20, photoswitch 30, manual switch 70, storage battery 60, collecting comb 80 and brush plate 90 are connected with the circuit board 50, and the circuit thereof is well known and not further described here.

By means of the above structure, when the manual switch 70 is turned on, the circuit does not conduct at this time, the photoswitch 30 would automatically detect the peripheral visibility. When the peripheral visibility is lower and lower and reaches the set value of the photoswitch 30, the photoswitch 30 would be automatically turned on such that the electricity stored in the storage battery 60 is transformed by the circuit board 50 and the electric current is transferred from and the positive brush 93 and the negative brush 92 on the bottom of the knob 10 to the negative comb 81 and the positive combs 82. The indicating lamp 40 connected by the negative brush 92 can emit light to enable the users to clearly recognize the position where the knob 10 has been adjusted.

When it is necessary to adjust the knob 10, the brush plate 90 would rotate along with the turn of the knob 10. At this time, the positive brush 93 always connects with the negative comb 81, and the negative brush 92 conducts with the different positive combs 82 along with the turn of the knob 10 thereby activating the different indicating lamps to clearly recognize the position of the knob 10.

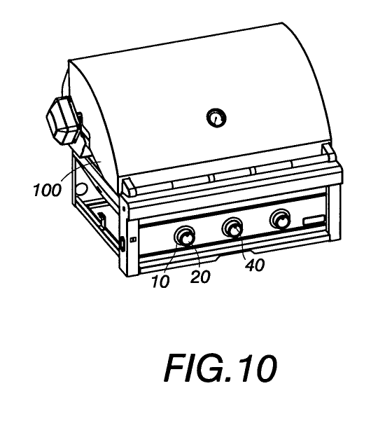

As illustrated in FIG. 10, there is a working state of the knob device according to the creation, which is used on an oven 100; as shown in the drawing, the solar panel 20 is located on the exterior of the knob 10, the surface of which is provided thereon with the indicating lamp 40. When the oven 100 is present where the illuminance is better, the solar panel 20 would transform solar energy into electricity; when the oven 100 exists where the visibility is worse, the knob device according to the creation can enable the indicating lamps to emit light.

What has been described above is the preferred embodiment of the creation only, and it is not intended to limit the scope of the creation. Various equivalent changes and alternatives to the creation can be made to the elements of the creation without departing from the spirit and scope of this creation. Accordingly, all such equivalent changes and alternatives should be included within the scope of the appended claims.

1. A solar illuminated knob device, comprising:
a knob rotatable in a manner so as to have an adjusting function;
a lighting component disposed within the knob, the lighting component including:
at least one indicating lamp, a solar panel, a storage battery, a switch and a circuit board, wherein said solar panel is fixed to the outer surface of the knob, said indicating lamp and said switch are installed on the knob, and the storage battery and the circuit board are disposed in the accommodating space inside the knob.

2. The solar illuminated knob device as described in claim 1, wherein: the indicating lamp is exposed and located on the outer surface of the knob.

3. The solar illuminated knob device as described in claim 2, wherein the knob is disposed on a knob base, and said knob base is a hollow ring with a “U” shaped or a triangular longitudinal section, a collecting comb; having positive and negative combs is disposed within the ring groove around the periphery of the knob base, and a brush plate matches the collecting comb,
wherein the brush plate is fixed to the bottom surface of the knob and can rotate synchronously with the knob, and positive and negative brushes are fixed to said brush plate corresponding to the positive and negative combs; and
at least one indicating lamp is fixed to said collecting comb.

4. The solar illuminated knob device as described in claim 3, wherein: there are six indicating lamps arranged uniformly around the periphery of the collecting comb.

5. The solar illuminated knob device as described in claim 1, wherein: the indicating lamp is a light emitting diode.

6. The solar illuminated knob device as described in claim 1, wherein: the knob is cylindrical, and the solar panel is installed on a circular front face of the knob.

7. The solar illuminated knob device as described in claim 6, wherein: said switch is a photoswitch, which is disposed on the outer surface of the knob.

8. The solar illuminated knob device as described in claim 7, wherein:
the switch further comprises a manual switch series connected with the photoswitch.
